(19) United States
(12) Patent Application Publication
(10) Pub. No.: US 2021/0074057 A1
(43) Pub. Date: Mar. 11, 2021

(54) SYSTEM FOR COMPUTING THE APPEARANCE OF WEAVE PATTERNS

(71) Applicant: Luxion, Inc., Tustin, CA (US)

(72) Inventors: Soren Gammelmark, Stavtrup (DK); Shuang Zhao, Irvine, CA (US); Henrik Wann Jensen, Del Mar, CA (US)

(73) Assignee: Luxion, Inc., Tustin, CA (US)

(21) Appl. No.: 16/563,871

(22) Filed: Sep. 7, 2019

(51) Int. Cl. G06T 17/00; G06F 17/50; G06T 7/00; G06T 7/40; G06T 11/00

(52) U.S. Cl. CPC G06T 17/00; G06F 17/5009; G06T 7/0002; G06T 2200/28; G06T 11/001; G06T 2200/04; G06T 7/40

(57) ABSTRACT

Embodiments include a system, apparatus, and method including a user inputting a 2 dimensional (2D) fabric weave pattern into a 2.5D appearance model, the 2.5D appearance model outputting a 3D appearance of the fabric weave pattern. The output includes light reflection information of the fabric, which includes shadows and scattered rays of light. The output also includes geometric surface variations of the fabric with micro detail on the object that is visible to a human eye. The output further includes flyaway fibers. The input 2D weave pattern of the fabric is editable by a user.

### 1. FIELD OF INVENTION

The present invention relates generally to a system, apparatus, and method for creating images from three-dimensional (3D) models, and more specifically, to a system for modeling the geometric variations and lighting of objects and scenes including woven fabric, such as clothing.

### 2. DESCRIPTION OF RELATED ART

One of the long standing challenges in computer generated imagery, better known as CGI, is the creation of output images including weave patterns of fabrics, where fabrics includes items with threads composed of fibers, the fabric including items such as clothes, blankets, curtains, and sheets.

CGI includes the generation of static and dynamic images. To generate CGI images of an object, CGI requires several descriptions of a scene containing the object, including: a description of the geometry in scene in the form of a 3D model; a description of the materials assigned to the geometry in the scene; and a description of the lighting in the scene.

Conventionally, these descriptions use a Bidirectional Reflectance Distribution Function (BRDF) model to represent the appearance of the 3D elements in the scene. The BRDF model mathematically describes the distribution of reflected light given an incoming lighting distribution. Combined with an algorithm such as ray tracing or rasterization it is possible to create images of the 3D model.

Sometimes, a more comprehensive appearance model is used, called a Spatially Varying (SV) BRDF model. The SVBRDF model accounts for variations across the surfaces of a 3D surface. This variation is typically represented using an image map (such as a photograph of wood grain used to represent a wood surface).

To create an image, a user is responsible for modeling all the visible geometry of an object or scene, and then specifying the BRDF or SVBRDF model needed to represent the appearance of the given object or scene. Both of the appearance models, BRDF and SVBRDF, typically rely on microfacet distributions that describe how tiny invisible variations in a surface structure of an object contribute to the appearance of the object's material.

For modeling many materials, especially smooth objects such as cars, wood tables, window glass, the BRDF and SVBRDF models can accurately represent the physical appearance. However, the BRDF and SVBRDF models fall short when modeling objects with micro detail that is too fine to represent in the 3D model but still affects the visible appearance. An example of an object with micro detail is fabric composed of threads visible to the human eye. These threads cast shadows and cause light variation on the micro level that is not captured accurately by the classic BRDF and SVBRDF models.

### SUMMARY OF THE INVENTION

Embodiments include a system, apparatus, and method including a user inputting a 2 dimensional (2D) fabric weave pattern into an appearance model, the appearance model simulating a 3D appearance of the fabric weave pattern.

Since the appearance model only takes a smooth surface as input, but creates a 3D appearance using the weave pattern, it is called a 2.5D appearance model in embodiments of the present invention. While the appearance model 120 is not a 3D model, it is a 2D model, the appearance model 120 has enhanced capabilities that makes the output appear to be 3D and thus is called a 2.5D appearance model herein.

The output of the 2.5D appearance model includes one or more images. The outputted images of the 2.5D appearance model includes detailed information of the geometric surface, the detailed information called the meso surface, created by the 2D weave pattern inputted into the 2.5D appearance model. The 2.5D appearance model enables the accurate computation of light reflected by the weave pattern and takes into account shadows and reflected light from the threads and fibers represented by the weave pattern. The output further includes flyaway fibers, which are fibers breaking out from the threads that they are a part of. The input 2D weave pattern of the fabric is editable by a user.

The present invention relates generally to a method, system, and apparatus for computing the appearance of weave patterns used in various forms of fabrics. The system enables a much more accurate visual simulation that accounts for geometric surface detail, also referred to as geometric surface variations or geometric variations, without the cost of explicitly constructing this detail.

The present invention is a new model for representing weave patterns. This new model, which may be called a 2.5D appearance model, enables a simulation of the appearance of fabrics using only a smooth geometric surface. The 2.5D appearance model uniquely accounts for the appearance of the surface detail including shadows cast by threads onto other threads, called self shadowing. To account for the appearance of the surface detail, the 2.5D appearance model leverages the fact that weave patterns are repetitive.

The 2.5D appearance model relies on a computation of various properties within the weave pattern. These computed properties include a two-dimensional distribution of heights, a two-dimensional distribution of tangents, and a two-dimensional distribution of normals. These heights, tangents, and normals reflect the structure of the actual surface of the fabric.

The 2.5D appearance model uniquely simulates how light is scattered by the individual fibers making up each thread, a novel feature. Conventional computer graphics algorithms, unlike the 2.5D appearance model, cannot compute self shadowing on flat surfaces. These conventional algorithms can only account for thread shadows by creating a complete volumetric representation of the fabric, which requires an impractical amount of storage and has not been used in practice.

Additionally, the 2.5D appearance model works with unique 2D weave pattern inputs, which may be entered manually and edited by a user. Further, the 2.5D appearance model accounts for the inputted 2D weave pattern's weaving structure, such as the ply count for each thread.

Further, the system has unique outputs including modeling flyaway fibers. Flyaway fibers are tiny fibers breaking out from the threads that they are a part of Therefore, these tiny flyaway fibers are aligned with the threads in the weave pattern and the flyaway fibers naturally inherit the color, and part of their orientation, from the underlying thread distribution. The addition of flyaway fibers to an outputted image adds realism to the weave pattern simulation.

An advantage of the invention is that the system simplifies the model by avoiding having to model every thread and fiber for an entire fabric object. The system accomplishes this simplicity by leveraging the inherent structure and repeatability of the pattern of the object, such that the system models weave patterns in a natural way.

This simplicity means that in addition to a user providing the inputs, a lightweight 3D CAD model can be used to input a 2D weave pattern into the new 2.5D appearance model. The lightweight 3D CAD model is different than the 2.5D appearance model in that the lightweight 3D CAD model is one way that a weave pattern can be inputted in to the 2.5D appearance model, or used to create 3D CAD surface that the 2.5D appearance model is outputted on to. Using the lightweight 3D CAD model, the new appearance model will compute the appearance of the 2D weave pattern while accounting for the appearance of threads and fibers as well as the local occlusion of threads. By using a completely smooth underlying lightweight 3D model as the input, this is a novel way of simulating a 3D appearance.

The lightweight 3D CAD model is considered smooth, or completely smooth, because the lightweight 3D CAD model only shows the overall surface an object. The smooth lightweight 3D CAD model does not show the thread and fiber detail. For example, when the object in an image to be outputted is a piece of clothing, the smooth lightweight 3D CAD model of the clothing does not show the thread and fiber detail of the clothing. The thread and fiber detail is completely missing from the smooth lightweight CAD model. The smooth lightweight 3D CAD model only shows the overall surface as if the cloth of the clothing is made of pieces of paper put together.

The foregoing, and other features and advantages of the invention, will be apparent from the following, more particular description of the preferred embodiments of the invention, the accompanying drawings, and the claims.

### BRIEF DESCRIPTION OF THE DRAWINGS

FIG. 1 illustrates a system for computing the appearance of a weave pattern according to one embodiment of the invention.

FIG. 2 illustrates a system for computing the appearance of a weave pattern according to another embodiment of the invention.

FIG. 3 illustrates an output of the system including flyaway fibers according to one embodiment of the invention.

FIG. 4 illustrates an output of the system including the 3D appearance of a fabric object according to one embodiment of the invention.

FIG. 5 illustrates a meso surface representation of the components used by the 2.5D appearance model to compute the appearance of threads according to one embodiment of the invention.

FIG. 6 illustrates a flow chart showing a process for computing the appearance of a weave pattern.

### DETAILED DESCRIPTION OF THE INVENTION

Before the present composition, methods, and methodologies are described, it is to be understood that this invention is not limited to particular compositions, methods, and experimental conditions described, as such compositions, methods, and conditions may vary. It is also to be understood that the terminology used herein is for purposes of describing particular embodiments only, and is not intended to be limiting, since the scope of the present invention will be limited only in the appended claims.

As used in this specification and the appended claims, the singular forms “a”, “an”, and “the” include plural references unless the context clearly dictates otherwise. Unless defined otherwise, all technical and scientific terms used herein have the same meaning as commonly understood by one of ordinary skill in the art to which this invention belongs. Any methods and materials similar or equivalent to those described herein can be used in the practice or testing of the invention, as it will be understood that modifications and variations are encompassed within the spirit and scope of the instant disclosure.

The present invention is able to take as an input a 2D weave pattern containing information about the organization of the threads within the weave pattern, and enter the 2D weave pattern into a highly detailed 2.5D appearance model capable of outputting a simulation of a wide range of fabrics from different weave patterns. The appearance model is called a 2.5D model herein because the appearance model receives as the input a smooth 2D surface, but creates as the output an image that gives a 3D appearance of the input. The highly detailed 2.5D appearance model computes a meso surface corresponding to the actual weave pattern geometry and uses the meso surface structure to compute the 3D appearance of the inputted 2D weave pattern. The 2.5D appearance model goes beyond traditional methods that use 2D images to create the appearance, and the appearance model is much more efficient than full volumetric methods that create a vast amount of geometric information.

The system may compute shadowing of threads by tracing a ray through a virtual meso surface representation (this can be a height field or another geometric representation in the space of the weave pattern), shadowing of threads may also be computed using a height value from a height field map, or the shadows can be pre-computed and represented using some functional basis such as spherical harmonics. The input weave pattern may include information about the threads ply value and the color of the weave pattern may be controlled using a texture applied to the 3D appearance model. The 3D appearance model may be modified using meso surface information. The threads can be flat and the threads can have eccentricity, which is a curved shaped.

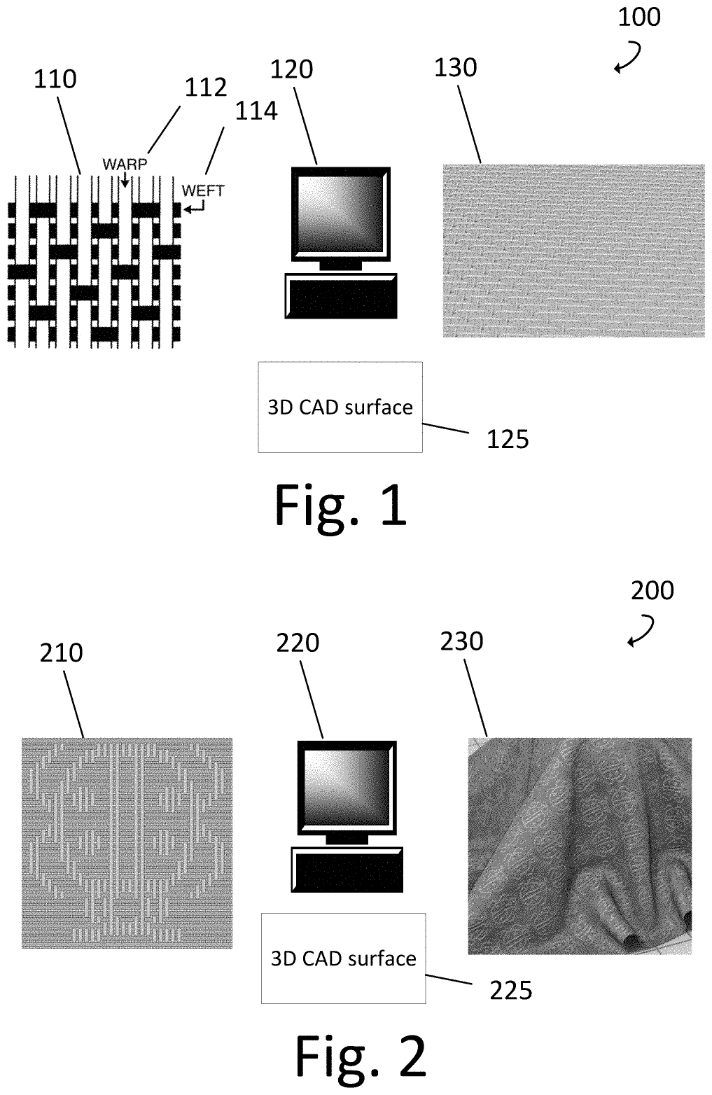

FIG. 1 illustrates a system 100 for computing the appearance of a weave pattern 110 according to one embodiment of the invention. The system 100 includes an input weave pattern 110, an appearance model 120, a 3D CAD surface 125, and a simulation output 130.

The weave pattern 110 is a 2D weave pattern that is input into the system 100. The weave pattern may be input by a user or by computer. The weave pattern 110 describes the layout of threads, including the warp threads or yarns 112 and the weft thread(s) or yarn(s) 114 that form a fabric. A warp thread 112 extends vertically through a weave pattern, with the edges of the warp threads 112 typically being held in stationary tension using a frame or device. A weft thread 114 extends horizontally through the weave pattern, the weft thread 114 inserted over and under the warp threads 112.

The weave pattern 110 includes a thread layout and thread type. The thread layout includes when a thread is above and below other threads, the roughness of the surface of each fiber, and the specular properties.

The thread type includes whether a thread is round or flat, the color of the thread, the transparency, and a ply count for the round threads. The system 100 uses the thread layout and thread type to compute the horizontal layout of the weave pattern 110, including the height at each location and the surface orientation (that is, the normal) of the thread or fiber at a specific location.

The weave pattern 110 allows a user to use the system 100, where the user either simply manually specifies the weave pattern 110 or the user or a CAD model inputs an already generated weave pattern.

For embodiments of this invention, the object is a fabric. A fabric is a cloth or other material produced by weaving together cotton, nylon, wool, silk, or other threads. Fabrics are composed of threads, and fibers spun into threads, where the threads are woven together in a pattern specific to the fabric type and appearance. Fabrics are used for making things such as clothes, blankets, curtains, cloth, and sheets, and as such, these things may be referred to as fabrics.

The 2.5D appearance model 120, also referred to as an apparatus, an appearance model 120, and an enhanced appearance model 120, receives the weave pattern 110 as the input, and the 2.5D appearance model 120 computes the actual thread organization of a fabric. The system 100 allows a user to edit the weave pattern 110, including editing the warp and weft threads, prior to the 2.5D appearance model 120 computing a 3D appearance of the 2D weave pattern of a fabric.

While the 2.5D appearance model 120 is not a 3D model, it is a 2D model, the 2.5D appearance model 120 has enhanced capabilities that makes the output 130 appear to be 3D, and thus is called a 2.5D appearance model herein. Specifically, the appearance model 120 outputs the 3D appearance of 2D weave patterns 110, onto the 3D CAD surface 125. As such, the simulation output 130 looks like it is made of threads with a given inputted weave pattern 110, and the simulation output 130 responds to light as if it was created by a 3D model, even though the appearance model 120 is only 2D, but is called 2.5D herein because of these enhanced capabilities.

Additionally, the appearance model 120 is a called a 2.5D model herein because the appearance model 120 receives as the input a smooth 3D CAD surface, but creates as the output 130 an image that adds 3D appearance details to the input. A main purpose of the 2.5D appearance model 120 is to create the output 130, which is images of the weave pattern applied to the 3D CAD surface 125. More precisely, the goal of the 2.5D appearance model is to enable ray tracing of 3D CAD surfaces 125 using the 2.5D appearance model 120.

The 2.5D appearance model 120 takes the user inputted or generated weave pattern 110 and creates a 3D appearance of the weave pattern by computing how the threads would need to deform to go over and under each other.

There are two methods that can be used for the purpose of creating the 3D appearance. The first method of creating the 3D appearance is a simple geometric method that forces the thread geometry to bend whenever there is a change from over to under. This first method creates flat sections of threads with angle transitions in the area where a thread goes either under or over another thread. A second method of creating the 3D appearance uses a relaxation approach to compute the physical stretching of the thread to create a more natural thread layout based on the physics of the thread.

The 3D CAD surface 125 is user created, and represents a smooth surface for the weave pattern 110 to be added to in the output 130. As a result, the 3D CAD surface 125 is inputted into the system 100, and together with the 3D appearance of the weave pattern 110, forms the simulation output 130.

The 3D CAD surface 125 is smooth underlying geometry created by the user. For example, when the object is a t-shirt, the user may create a 3D model of a t-shirt representing the 3D CAD surface. This user created model of the t-shirt will represent the clothing, but it will not contain the very fine detail contained in a weave pattern, such as the threads making up the clothing. In this example, this user model can form the surface for the appearance model 120 to output on to. The 2.5D appearance model 120 can be applied to this surface 125, such that the simulation output 130 looks like it is made of threads with a given weave pattern. The simulation output 130 responds to light as if it was created by a 3D model, but since the appearance model 120 is only 2D, the appearance model 120 is called 2.5D herein as it has these enhanced capabilities.

While the 3D CAD surface 125 is an input to the system 100, the 3D CAD surface 125 is illustrated adjacent to the appearance model 120 to indicate in embodiments that the 3D CAD surface 125 is not an input to the appearance model 120. In other embodiments, the appearance model 120 receives the 3D CAD surface 125 from a lightweight 3D CAD model as an input, to output the weave pattern on to the 3D CAD surface 125.

The simulation output 130, also referred to herein as output 130 and image 130, illustrates an output of the system 100 including the 3D appearance of a fabric object represented by the 2D weave pattern 110. The simulation output 130 is a 2D image which has the appearance of being a 3D image due to shadows and threads. The simulation output 130 is a 3D appearance based on the input 2D weave pattern of the fabric, the 3D appearance applied to the 3D CAD surface 125 created by, a CAD model of the smooth underlying surface. The images can be any computer generated image, such as a static image or picture, a graphics interchange format (GIF) image, or a 3D animation or movie. The simulation output 130 captures light reflection information and geometric surface variations.

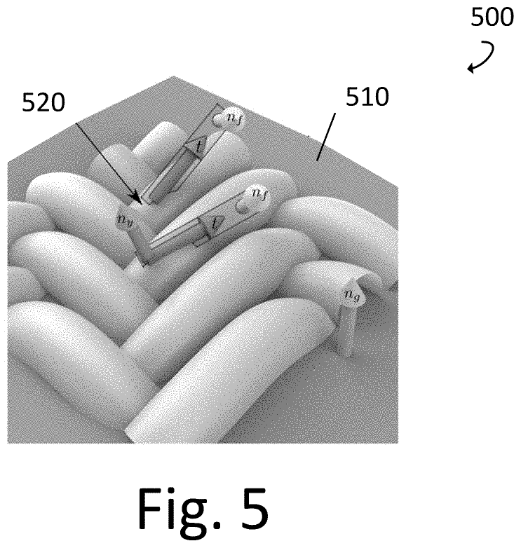

Light reflection information, captured by the simulation output 130, includes information about all light reflected by the appearance model 120. All light includes light reflections from a light source, light reflection between threads, and shadows caused by the threads. For a light source, the light reflection information includes a representation of a ray of light that is scattered off a fiber of the fabric. For reflection between threads, the 2.5D appearance model 120 can model light reflected between threads because the appearance model 120 uses a surface that is not flat, discussed with respect to a meso surface 520 in FIG. 5. If the surface was flat, then a reflected ray could not hit another part of the surface, but with the enhanced appearance model 120, the output 130 illustrates the light reflected between threads. In the case when the reflected light is shadows, the reflected light will be darker.

Geometric surface variation, captured by the simulation output 130, is a non-smooth surface created by the threads and fibers making up the cloth. Geometric surface variation is not present in the smooth 3D CAD surface 125 created by a user. The 2.5D appearance model 120 creates the geometric surface variations (e.g., threads, flyaway fibers, etc.) using only the weave pattern 110 including the additional appearance information entered by a user.

The simulation output 130 captures the geometric variations, also referred to as geometric surface variations, geometric detail, and meso surface detail, of the 2D input weave pattern, including threads that occlude each other. By contrast, traditional methods for imaging fabrics only represent the captured shading variation across a flat surface because they rely on scanning flat samples of the fabric. Additionally, with traditional methods, it is impossible to for a user to edit the weave pattern or the appearance of the threads, as this information is locked into the captured images. Further, conventional methods relying on scanning flat samples also fail to capture fine detail such as the appearance of flyaway fibers because this conventional approach models the weave pattern as an entire volume and as such this conventional approach is completely impractical and it does not allow for dynamic simulations where the underlying model is deformed.

FIG. 2 illustrates a system 200 for computing the appearance of a weave pattern 210 according to one embodiment of the invention. Like the system 100, the system 200 includes an object that is a fabric or a scene containing a fabric. Also, the weave pattern 210 is in 2D, the weave pattern 210 is editable by a user prior to computations, and the weave pattern 210 includes warp and weft threads. Although the system 200 is similar to the system 100, the system 200 uses a different design, different colors and sizes for the input weave pattern 210, and the system 200 produces a simulation output 230 which illustrates shadows. The simulation output 230 includes a 3D appearance of the 2D weave patterns 210 on a 3D CAD surface 225. Further, while the weave pattern 110 may have been automatically loaded onto the system 100 from an existing weave pattern, the weave pattern 210 may be created manually by a user using an interface of system 200.

The inputted weave pattern 210 defines a 2D pattern of threads. The weave pattern describes an over and under description of the threads as well as the color of the threads. For a user to manually create the weave pattern 210, the user specifies over and under patterns for the weft and warp threads. Furthermore, the user can specify thread appearance attributes such as color, surface roughness, thread eccentricity, and transparency.

The weave pattern 210 contains information about a fabric's thread appearance and thread structure. The thread's appearance includes a thread's color, surface roughness, reflectivity, etc. The thread's structure includes the organization of the threads, where the threads are organized into two basic components, warp and weft. Warp is the threads in the length wise direction and weft is the threads in the transverse direction that goes over and under warp threads to form a weave pattern. This thread structure and appearance are described by the weave pattern.

The 2.5D appearance model 220 can be the same as the 2.5D appearance model 120, where the weave pattern 210 is loaded into system 200 and a user can edit the weave pattern 210. The 2.5D appearance model 220 receives the inputted weave pattern 210, the user inputted CAD surface 225, and the 2.5D appearance model 220 computes a meso surface structure, which could be a 2D height field based on the computed layout of the threads. The 2.5D appearance model 220 takes as input a 3D CAD surface, where each surface point is identified by a 3D location, a 3D surface normal, and a 2D surface (texture) coordinate. The 2.5D appearance model 220 computes the light reflected, including the actual shading, from a point on a 3D surface by using the meso surface and the 2D weave pattern 210. The shadowing of threads may be computed by tracing a ray through a virtual height field from the inputted 2D weave pattern 210, the shadowing maybe be computed using the height value in the height field map, or the shadowing may be pre-computed and represented in a functional basis such as spherical harmonics. The 2.5D appearance model 220 uses maps of the weave pattern 210 to compute actual thread geometry, used for computing the occlusions causing shadows and affecting reflections.

In one embodiment, the 2.5D appearance model 220 includes a ray tracing algorithm to create image lighting with the geometry of the input weave pattern 210. The ray tracing algorithm uses rays of light to simulate the interaction of light with a given element in the scene. When a ray intersects the surface, the system 200 finds the location within the weave pattern 210 that corresponds to the particular surface location. At this location, the system 200 performs a visibility check, which is a check for the visibility of any light by tracing a ray towards each light.

The ray tracer's visibility check uses pre-computed meso surface information in the weave pattern to check locally if any occlusion is present. This visibility check can be done by tracing a ray through a 2D height field for which standard algorithms exist. Furthermore, a specular ray may be traced. The direction of this ray is determined from the height and the fiber orientation at the location combined with the appearance information including the specular color, transparency, and fiber surface roughness. The specular ray also uses the height information to check for any occlusion as the specular ray leaves the surface with the weave pattern.

Further, a ray is traced to compute indirect illumination. The direction of this ray is based on the height information and the fiber orientation as well as the appearance information. The ray tracer uses the meso surface to test for local occlusions. If a height field is used to represent the meso surface then the occlusion test that is applied for shadowing, specular reflections and indirect illumination can assume a locally flat surface to enable very fast ray tracing of the height field data.

The ray tracing algorithm creates an image of the fabric. The ray tracing algorithm works by intersecting the scene with a ray, that is, a geometric line. When the ray intersects a fabric surface, the system 200 computes the exact intersection with the underlying CAD model. This intersection location yields a 3D position, a 3D normal, and a 2D texture parameter. The 2D texture parameter is used to index into the weave pattern and the pre-computed geometry for this weave pattern. This indexing allows the ray to estimate the actual normal of the weave pattern fibers. This actual meso surface normal is used for shading.

To compute shading, the ray tracing algorithm traces one of more rays from the surface intersection location, that is, the 3D position found from the CAD model. To account for thread shadowing, the system 200 traces the ray through the weave pattern geometry (the meso structure) to account for any local blocking of the light. In addition, the system 200 can use the height to estimate an approximate fabric self shadowing amount.

The 3D CAD surface 225 is user created, and represents a smooth surface for the weave pattern 210 to be added to. As a result, the 3D CAD surface 225 is inputted into the system 200, and together with the 3D appearance of the weave pattern 210, forms the simulation output 230.

The simulation output 230, like simulation output 130, illustrates an output of the system 200 including the 3D appearance of a fabric object represented by the 2D weave pattern 210 on the 3D CAD surface 225 inputted by a user. Here, the output 230 is an image. The outputted image 230 is an illustration of a blanket with multiple beetles woven thereon. The simulation output 230 reproduces the appearance of the fabric as if a physical sample had been created from the specific weave pattern 210.

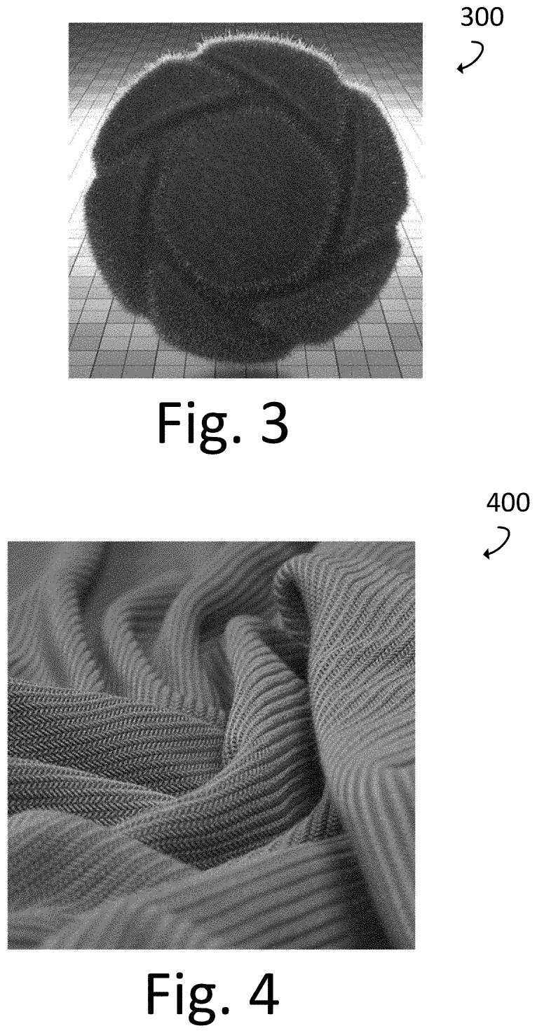

FIG. 3 illustrates an output 300 of the system including flyaway fibers according to one embodiment of the invention. This image shows flyaway fibers visible along the contour of the surface of a sphere. The 2.5D appearance model can add these flyaway fibers using location information from the input 2D weave pattern.

FIG. 4 illustrates an output 400 of the system including the 3D appearance of a fabric object according to one embodiment of the invention. The output 400 is a 2D image which has 3D appearance details in the weave pattern due to shadows and threads. This simulation output 400 is created by initially receiving a 2D weave pattern and appearance information, then a 2.5D appearance model combines the weave pattern and appearance information along with a 3D geometric model of smooth fabric geometry. Appearance information including the specular color, transparency, and fiber surface roughness. With this information, the appearance model outputs a highly detailed image that accounts for shadowing from the threads without explicitly creating this detailed geometry.

FIG. 5 illustrates a meso surface representation 500 of the components used by the 3D appearance model to compute the appearance of threads according to one embodiment of the invention. The meso surface representation 500 includes a geometric surface 510 and a yarn meso surface 520.

The geometric surface 510 is a flat 2D surface is a flat 2D surface with a normal to the geometric surface ng. The yarn meso surface 520 is a 3D illustration of threads from a 2D weave pattern, the threads entering and exiting the 2D surface. The yarn meso surface contains information about the yarn surface location and the orientation of the threads, which is used to compute the appearance of the yarn. While the yarn meso surface 520 is never created, it can be used to create the simulation output of the fabric

The meso surface 520 is a geometric representation of the true surface created by the threads and fibers that compose the weave pattern. The meso surface is a 3D surface, where each point on the surface includes a normal to a yarn ny, a thread direction t, and a thread tangent direction nf. The meso surface representation 500 receives an input 2D weave pattern, and computes the effect to the 2D weave pattern on the flat geometric surface 510.

The 2.5D appearance model can model light reflected between threads because the meso surface 520 is not flat. If the surface was flat, then a reflected ray could not hit another part of the surface, but with the enhanced appearance model, the simulation output illustrates the light reflected between threads.

The system uses the repetitive nature of a given input 2D weave pattern to compute the meso surface representation 500 for the given input weave pattern. The input weave pattern is repeatedly mapped to the underlying CAD geometry and each location of the CAD geometry identifies a unique position within the weave pattern. Given this location, the system computes height and fiber orientation, and then applies a fiber shading model to compute the intensity of the reflected light from the given fiber for any given incoming lighting distribution.

The meso surface is only computed for the specific weave pattern, that is, the meso surface is not computed for the full CAD geometry onto which the weave pattern is applied, which is important. A key insight is that the weave pattern is repeated over the surface many times. It is generally too compute intensive and often even impossible to represent the full fiber geometry over the entire CAD geometry. In contrast, the system's pre-computation of the meso surface structure is compact and efficient to represent.

Further, the system leverages the 3D information contained in the pre-computed meso structure to compute accurate shadowing of threads onto each other. For lighting, the system can use three methods. One method simply relies on the computed height value and uses a linear interpolation between in shadow for the lowest point and fully lit for the highest point on the surface. This is a fast calculation that works well due to the organized layout of the threads. A second method uses ray tracing within just the pre-computed meso surface to check if any other parts of the local surface block the light. A third method uses a functional basis such as spherical harmonics to represent the local shadowing within the weave pattern. This functional basis can be pre-computed and stored for fast lookup later.

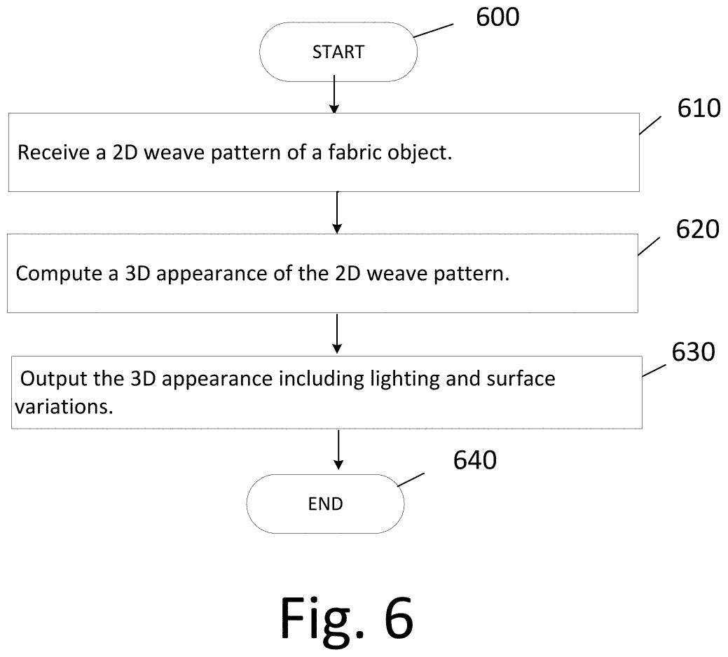

FIG. 6 illustrates a flow chart showing a process for computing the appearance of a weave pattern. The process starts at step 600. At step 610, the system receives a 2D weave pattern, such as 2D weave patterns 110, 210, of a fabric object, such as clothes or a blanket. Next, at step 620, the 3D appearance model computes a 3D appearance of the 2D weave pattern of the fabric object. At step 630, the system outputs the 3D appearance of the fabric object including lighting and surface variation, such as light reflection information and geometric surface variations of the fabric, such as simulation outputs 130, 230, 300, and 400. The process ends at step 640.

It is to be recognized that depending on the embodiment, certain acts or events of any of the methods described herein can be performed in a different sequence, may be added, merged, or left out altogether (for example, not all described acts or events are necessary for the practice of the method). Moreover, in certain embodiments, acts or events may be performed concurrently, for example, through multi-threaded processing, interrupt processing, or multiple processors, rather than sequentially.

The steps of a method or algorithm described in connection with the embodiments disclosed herein may be embodied directly in a computer or electronic storage, in hardware, in a software module executed by a processor, or in a combination thereof. A software module may reside in a computer storage such as in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

It should be understood that the invention is not limited to the embodiments set forth herein for purposes of exemplification, but is to be defined only by a fair reading of the appended claims, including the full range of equivalency to which each element thereof is entitled. Although the invention has been described with reference to the above examples, it will be understood that modifications and variations are encompassed within the spirit and scope of the invention. Accordingly, the invention is limited only by the following claims.

What is claimed is:

1. A system comprising:
a 2 dimensional (2D) weave pattern including appearance information of a fabric;
a 3D CAD surface;
a 2.5D appearance model to receive the 2D weave pattern and to compute a 3D appearance of the 2D weave pattern of the fabric; and
a simulation output representing the 3D appearance of the 2D weave pattern of the fabric applied to the 3D CAD surface, wherein the simulation output includes light reflection information of the fabric and illustrates geometric surface variations of the fabric.

2. The system of claim 1, wherein the light reflection information includes a shadow.

3. The system of claim 1, wherein the light reflection information includes a representation of a ray of light that is scattered off a fiber of the fabric.

4. The system of claim 1, wherein the 2D weave pattern is editable by a user.

5. The system of claim 1, wherein the geometric surface variations of the fabric include one or more of: threads occluding, micro detail on an object that is visible to a human eye, or flyaway fibers.

6. The system of claim 1, wherein the 3D appearance model computes one: of a shadow cast by a thread on another thread or a reflection of incoming light.

7. The system of claim 1, where the threads are composed of fibers.

8. The system of claim 1, wherein the 2D weave pattern is input by a user or by a 3D computer-aided design (CAD) model.

9. The system of claim 1, wherein the 3D appearance model uses a ray tracing algorithm to generate the simulation output, wherein the ray tracing algorithm simulates the light reflection information.

10. The system of claim 1, wherein the simulation output includes one or more 3D computer generated images including one or more of: a picture, a 3D animation, or a graphics interchange format (GIF) image.

11. The system of claim 1, wherein the 2D weave pattern includes one or more of: a 2D distribution of thread heights, a 2D distribution of thread normals, when a thread is above or below other threads, whether the thread is round or flat, a color of the thread, a transparency of the thread, a roughness of a surface of fibers of the thread, specular properties of the thread, or a ply count.

12. A method comprising:
receiving a 2 dimensional (2D) weave pattern including appearance information of a fabric;
receiving a 3D CAD surface;
computing a 3D appearance of the 2D weave pattern of the fabric using a 2.5D appearance model, the 2.5D appearance model to receive the 2D weave pattern; and
outputting a simulation output representing the 3D appearance of the 2D weave pattern of the fabric applied to the 3D CAD surface, wherein the simulation output illustrates light reflection information of the fabric and illustrates geometric surface variations of the fabric.

13. The method of claim 12, wherein the light reflection information includes a shadow.

14. The method of claim 12, wherein the light reflection information includes a representation of a ray of light that is scattered off a fiber of the fabric.

15. The method of claim 12, wherein the 2D weave pattern is editable by a user.

16. An apparatus comprising:
an input for receiving a 2 dimensional (2D) weave pattern including appearance information of a fabric;
a 2.5D appearance model coupled to the input, the 3D appearance model to receive the 2D weave pattern and to compute a 3D appearance of the 2D weave pattern of the fabric; and
an output coupled to the 2.5D appearance model, the output including a simulation output representing the 3D appearance of the 2D weave pattern of the fabric, wherein the simulation output illustrates light reflection information of the fabric and illustrates geometric surface variations of the fabric.

17. The apparatus of claim 16, wherein the light reflection information includes a shadow.

18. The apparatus of claim 16, wherein the light reflection information includes a representation of a ray of light that is scattered off a fiber of the fabric.

19. The apparatus of claim 16, wherein the 2D weave pattern is editable by a user.
